(19) United States
(12) Patent Application Publication
(10) Pub. No.: US 2005/0015370 A1
(43) Pub. Date: Jan. 20, 2005

(54) Information management system and method

(76) Inventors: Donald J. Stavely, Windsor, CO (US); Ted B. Ziemkowski, Loveland, CO (US); Matthew Flach, Fort Collins, CO (US); Kel D. Winters, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/619,225

(22) Filed: Jul. 14, 2003

(51) Int. Cl. G06F 17/30; G06K 9/00; G09G 5/00; G06F 17/00

(52) U.S. Cl. 707/6; 715/738; 707/3; 382/181; 715/805; 715/808; 707/104.1; 382/275

(57) ABSTRACT

A system and method is disclosed for delivering information comprising identifying a graphic symbol within an electronic image, communicating the symbol to a database of existing graphic symbols, matching the graphic symbol to one of the existing symbols, and transmitting information associated with the symbol to the electronic image.

### TECHNICAL FIELD

The present invention relates, in general, to information management systems, and, more specifically, to presentation of information responsive to detected visual symbols.

### BACKGROUND OF THE INVENTION

The Internet and the World Wide Web (WWW) permeate many aspects of society today. What originally began as a means for scientists at different educational and research institutions to exchange information has turned into a globally accessible marketplace of goods, services, and ideas. Perhaps the most important and powerful feature of the WWW is the hyperlink. Hyperlinks, which are selectable objects within a displayed page, allow a user to load a Web page at the uniform resource locator (URL) address associated with the hyperlink. By selecting the hyperlink and loading the new pages, the user is allowed to “surf” from one page to the next. These hyperlinks may be text words that are highlighted or otherwise made visually distinctive as a cue to the user that they are selectable or “clickable.”

It is also possible to embed a hyperlink within a graphic or an image. For example, it is common to present a map on a web page with “clickable” locations, such as countries, states, cities, and the like. These “clickable” locations are typically hyperlinks associated with a particular image or a particular place on an image that, if selected, load a new web page at the URL corresponding to the hyperlink. Similarly, a picture of a group of people, such as a school faculty or a family, may be made such that each person, or the position on the image where the person is, may be “clicked on” to take the user to that person's web page.

Adding hyperlinks to an image is usually a manual process. Web page designers typically determine which parts of the image are to be associated with a URL and then program those links to the particular object. While this programming is not especially difficult for individuals familiar with web development, it does require some degree of familiarity with computers and web programming. The average consumer will not likely have the skills or the tools to effectively incorporate information into items in such a manner.

### BRIEF SUMMARY OF THE INVENTION

Representative embodiments of the present invention are directed to a method for delivering information comprising identifying a graphic symbol within an electronic image, communicating the graphic symbol to a database of existing graphic symbols, matching the graphic symbol to one of the existing graphic symbols, and transmitting information associated with the graphic symbol to the electronic image.

Additional representative embodiments of the present invention are directed to an information management system comprising client-side logic executable by a client processor for detecting a unique graphic symbol displayed within a visual image, and server-side logic executable by a server for matching the unique graphic symbol to at least one of a plurality of stored graphic symbols and returning data corresponding to the matched unique graphic symbol to the client-side logic.

Further representative embodiments of the present invention are directed to a method for automatically distributing information to a consumer comprising registering a unique graphic symbol with an information management service, storing information related to the unique symbol in a database, placing the unique symbol in conspicuous locations, receiving an image of the unique graphic symbol at the information management service automatically acquired from a picture provided by the consumer, searching the database to match the image to the unique graphic symbol, and transmitting the information related to the unique symbol to the picture when a match is found.

### BRIEF DESCRIPTION OF THE DRAWINGS

For a more complete understanding of the present invention, reference is now made to the following descriptions taken in conjunction with the accompanying drawing, in which:

FIG. 1A is an illustration of an exemplary graphic symbol encoded with a dimensional barcode;

FIG. 1B is an illustration of an exemplary graphic symbol having a human-recognizable logo;

FIG. 2A is a system diagram illustrating one embodiment of the information management system described herein;

FIG. 2B is a system diagram illustrating another embodiment of the information management system described herein;

FIG. 2C is a block diagram illustrating the components utilized in one embodiment of information management system described herein;

FIG. 3 is an illustration of a picture that has a captured symbol in one embodiment of the information management system described herein;

FIG. 4 is an illustration depicting an image symbol of the symbol captured from FIG. 3 after cropping;

FIG. 5 is an illustration of a picture that has been updated with the information transmitted from the symbol registry;

FIG. 6A is an illustration of a picture having a graphic symbol configured to interact with one embodiment of the information management system described herein;

FIG. 6B is an illustration of a picture updated with the related information from the information management system;

FIG. 7 is an illustration of a picture having a graphic symbol configured to interact with another embodiment of the present invention; and

FIG. 8 is a flow chart depicting a representative method for implementing one embodiment of the information management system described herein.

### DETAILED DESCRIPTION OF THE INVENTION

One embodiment of the information distribution system described herein is a system and method for automatically identifying a unique graphic symbol anywhere in an image, and replacing it with a hyperlink, metadata, an applet, or other type of information or logic. The hyperlinks may provide direction to pages associated with landmarks, locations, places of businesses, brands, people, and the like. The owners of the graphic symbols may register with one or more registry database services. The symbol-owners may then prominently display the symbols in public view on signs, storefronts, clothing, advertisements, and the like. Users taking pictures may, either incidentally or purposefully, capture and include the graphic symbols somewhere within the frame of the picture. When the user uploads the pictures from the camera to a personal computer (PC) or to a web site, a software application may identify that the picture contains such a graphic symbol. The camera, PC, or web site may then send an image of the graphic symbol from the picture to the database service, which matches the captured image of the symbol to the copy of the symbol in the registry's database and then returns the symbol-owner's information.

Existing systems have inserted hidden symbols or codes that were used for identification of audio and visual material. One such system is described in U.S. Pat. No. 6,567,535 issued to Rhoads. However, the Rhoads' system used symbols or codes that were not visually obvious to people in general.

In cases where the information returned in the present information management system is a web address, the application may embed a hyperlink associated with the image, or save it, alternatively, as a hypertext markup language (HTML) file, metadata, or the like. When the user views the picture thereafter in a web browser or other compatible viewer, the associated image has now become “clickable” which, when selected by the user, may direct the web browser or similar viewer to the hyperlinked address. The “clickable” region may consist of the entire image, or a sub-region of the image consisting of or containing the graphical symbol itself. “Clickability” may be indicated to the user by special text or icon, or by a change in the cursor when the region is “rolled over by the cursor”. This is similar to the change in cursor from an arrow to a pointing finger when placed over a hyperlink on a conventional web page.

At that address, the user may generally obtain additional information present at the web site. Other types of information may result in other visual indicators, such as pop-up boxes or even shortcuts to run applets or larger applications.

In order to facilitate the exchange of information based on the capture of the symbols, each visually distinctive symbol may be registered in one or more public database services. Image recognition software or firmware may attempt to identify one or more possible or “candidate” graphical symbols in a picture. If one is identified, it may then be sent to the database, which, when cross-referenced against the database of symbols, returns a web address or information which is used to create an interactive interface within the picture images.

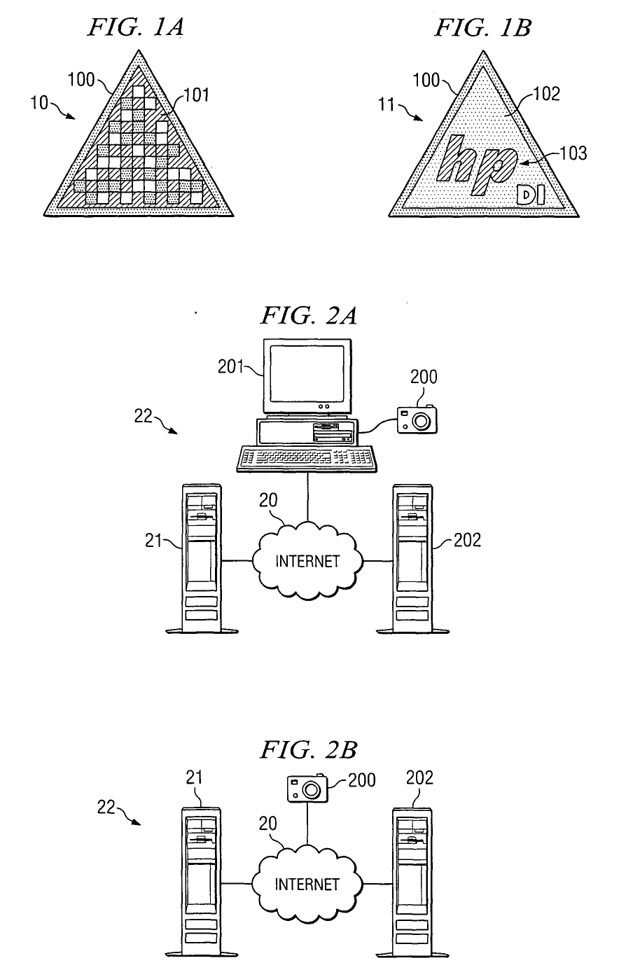

Consideration should be taken to make each of the graphic symbols easy to read by machine despite changes to scale and perspective in the user's picture. Many different formats may be used to create symbols that are easily distinguishable from one another, yet have the capacity to represent a sufficient number of different entities. A one- or two-dimensional barcode may be one of the simplest choices. FIG. 1A is an illustration of exemplary symbol 10 encoded with dimensional barcode 101. By using only a modest number of bits, millions or even billions of possible symbols may be separately represented, yet distinguishable by the image identification logic. Dimensional barcode 101 may be created using a set of distinct color-pairs with a distinct color for border 100 to make detecting the embedded code easier.

A concept used in visual codes is that of digital distance. Digital distance is the amount that one code is different from another. In order to accommodate for loss of sharpness or changes in the graphic symbol orientation, the digital distance in the graphic symbols/codes associated with the present system should be large enough to allow some flexibility in the code. For example, codes that have a digital distance of only one bit may not be differentiable if the captured image of the symbol or code is too blurry or distorted to distinguish a bit difference.

A graphic symbol may alternatively be a simplified logo that is also human-recognizable using technology which is well-understood in the industry. FIG. 1B is an illustration of exemplary symbol 11 having human-recognizable logo 103. Symbol 11 may also be created using sets of coordinated color-sets for border 100, background 102, and logo 103. An important part of maintaining a registry of such logo symbols would be to ensure that new symbols are visually differentiable from currently registered symbols. Each graphic symbol should be visually unique and may be registered with some kind of agency or entity in order to track legal ownership. This is much like the registry of cattle brands used to track ownership in the American West. Brands could only be registered if they were different enough from previously registered brands to avoid misrecognition or intentional tampering. This is the visual equivalent of the “digital distance” concept described above.

In some embodiments of the described information management system, a multi-format system may be employed in which some symbols comprise graphical symbols while other symbols comprise some kind of dimensional code. The different methods for distinguishing the graphic symbols, such as specific color schemes, shapes, sizes, and the like assist the information management system to identify the particular symbol or code.

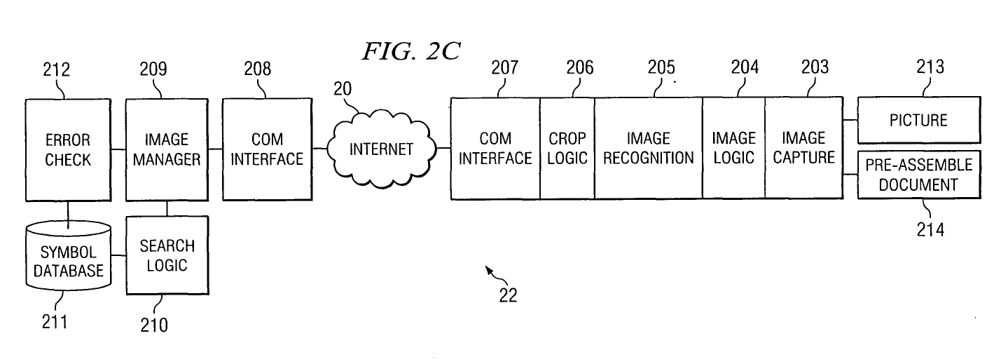

FIG. 2A is a system diagram illustrating one embodiment of information management system 22. Camera 200 has been used to take pictures which may include a symbol, as described herein. As the user downloads the pictures from camera 200 to PC 201, an application running on PC 201 examines each picture looking for one or more regions of the image that could be one or more symbols. If a possible or “candidate” symbol is found, the application may crop the pictures to leave only the image captured of the symbol and send the captured candidate symbol image over Internet 20 to symbol registry 202. The registry application running on symbol registry 202 checks the symbol image against its database of registered graphic symbols. Because the image of the symbol may have been captured at a different angle or resolution, symbol registry 202 includes logic that may normalize the scale, orientation, and perspective of the symbol image, or, if the symbol image is blurry, it may attempt to clear or sharpen the image to make comparison against the database symbol versions more efficient.

If symbol registry 202 finds a match with the candidate symbol image, information that has been associated with the symbol on symbol registry 202 will then be transmitted across Internet 20 back to PC 201. The application on PC 201 that manages information management system 22 then overlays the information onto the corresponding picture. The overlay may comprise a hyperlink to a particular website, or may comprise metadata, or visual data that may be displayed when a user rolls his or her cursor over the symbol. Furthermore, the downloaded information may include an applet or application that will execute to a runtime when the user either rolls over or selects a visual indicator on the symbol.

If symbol registry 202 does not find a reliable match for the candidate symbol image, the server will return a message as such. The application on PC 201 will then take no action, i.e. nothing will be embedded in the image. This minimizes the possibility of associating incorrect information with a graphic symbol, or inserting information in an image that actually contains no graphic symbol at all.

In another embodiment, also depicted in FIG. 2A, neither camera 200 nor PC 201 may have the client-side logic or software for information management system 22. In these cases, the pictures may be uploaded to remote picture server 21 over Internet 20. As the pictures are uploaded to server 21, client-side logic embedded on server 21 analyzes the pictures to find evidence of one or more symbols captured in the picture. Server 21 may then crop and send the symbol to symbol registry 202 to perform the search, comparison, and information transmission as previously described with server-side logic. Exemplary information management systems 22 could include digital photography or “picture sharing” websites. Users routinely upload many or all of their digital photos to these websites. Note that server 21 and information management system 22 may be integrated into a single physical or logical server system.

FIG. 2B is a system diagram illustrating another embodiment of information management system 22. In the illustrated embodiment, camera 200 includes the client-side logic for use with information management system 22. When the user takes pictures with camera 200, the client-side logic analyzes each picture attempting to find a symbol captured therein. If the client-side logic finds an image that may be a symbol, it may crop the picture to send only the symbol image to symbol registry 202 over Internet 20. It should be noted that in alternative embodiments, the entire picture may be transmitted to symbol registry 202. However, by cropping the image first, less bandwidth is required to send the symbol.

Another embodiment of information management system 22 shown in FIG. 2B allows camera 200 to take advantage of information management system 22 when it does not include the client-side software for managing the symbols. The pictures may be uploaded directly from camera 200 to remote picture server 21. Server 21 includes the client-side logic necessary to detect and extract any symbols that may be present in the uploaded pictures and send those to symbol registry 202 over Internet 20. Consequently, symbol registry 20 may search for and transmit any related information that may correspond to symbols that are detected and matched within the symbol database. Again, exemplary information management systems 22 could include digital photography or “picture sharing” websites.

It should also be noted that while the embodiments described with FIGS. 2A and 2B illustrate symbols being captured by camera 200, various embodiments of the information management system described herein may also include symbols that are electronically or physically affixed to advertisements or other such visual media. In these cases, the information associated with the symbol may be accessed either if the documents are electronic or if the physical documents are thereafter electronically captured by an appliance that has Internet access.

FIG. 2C is a block diagram illustrating exemplary components utilized in one embodiment of information management system 22 described herein. In order to place the picture into a format that may be analyzed, image capture logic 203 may take visual information either from picture 213 or from pre-assembled document 214 and may capture that visual information into an electronic image. Image logic 204 may manage the captured images for presentation to the user or for transmission to symbol registry 202 (FIG. 2A, 2B). Image recognition logic 205 may then search and analyze each picture to determine whether some form, version, or orientation of an information symbol is present on the image.

In certain embodiments, crop logic 206 may also be included to crop down the image to comprise just the candidate symbol image of interest. Once cropped, communication interface 207 packages and sends out the symbol image to symbol registry 202 (FIG. 2A, 2B) over Internet 20 for further analysis. Communication interface 208 may receive and prepare the transmitted symbol image at the remote location. Image manager 209, may assemble the symbol images and submit each symbol to search logic 210 to compile a search of symbol database 211 for possible matches. Search logic 210 may use graphics imaging logic to manipulate the image of the symbol to correct for orientation, perspective, scale, and/or resolution prior to performing the search with symbol database 211. Error check logic 212 may then analyze the one or more possible matches to determine which match may be the most accurate and then return the associated information with the matched symbol to image manager 209 for transmission by communication interface 208 through Internet 20. By associating the symbol with the information in symbol database 211, vendors or other symbol owners may routinely update and change the associated information without having to change the actual symbol.

The associated information may include a name, address, phone number, web address, and the like. The software application may save this information in the image as metadata. This or other applications now may respond to the user by displaying the metadata. This or other applications now may respond to the user by displaying the metadata whenever the image is displayed, is “clicked on,” “rolled over,” or otherwise selected.

Note that the appliance or the client software application is generally responsible for recognizing that the picture contains one or more candidate symbols. This is desirable so that every image need not be sent to the central service at full size and resolution. Only the bitmap of the candidate symbol itself, if found, is cropped and transmitted to be analyzed remotely. This implies that every symbol should generally contain a common and easily machine recognizable characteristic or element. One option is for symbols to share a common shape or outline. For example, symbols from one information management service may all be blue triangles with black borders, inside of which are the uniquely registered symbols themselves. Other services may use different shapes or color schemes. The local application scans each of the user's images, searching for blue triangles with black boarders anywhere in them. If found, they are sent to the registry service, which verifies the symbol and matches the remaining graphical content of the symbol to an owner as described above.

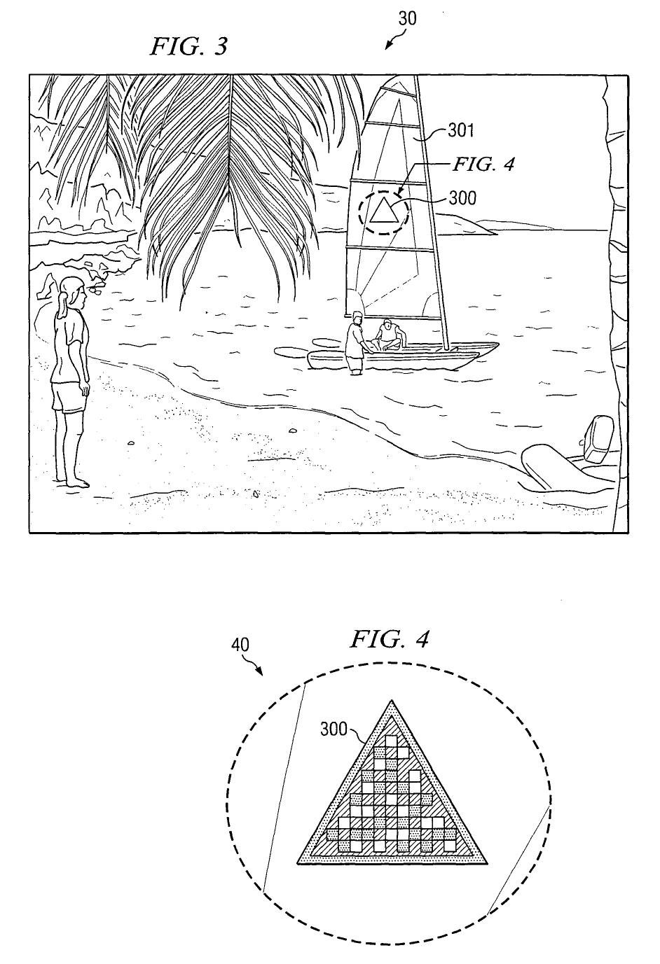

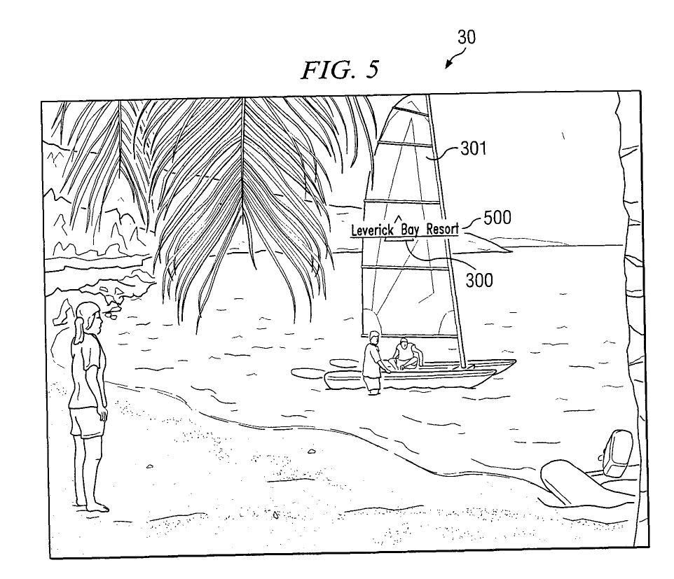

FIG. 3 is an illustration of picture 30 that has captured symbol 300 in one embodiment of the information management system described herein. Picture 30 shows catamaran 301 having graphic symbol 300 centered in the middle of its sail. The client-side software analyzes picture 30 and finds the visual information that appears to correspond to graphic symbol 300. In one embodiment, the client-side software of the information management system crops picture 30 to leave only graphic symbol 300. FIG. 4 is an illustration depicting image symbol 40 of graphic symbol 300 after cropping. Image symbol 40 would then be transmitted to the remote symbol registry to determine whether image symbol 40 matches any of the symbols stored in the symbol registry. If such a match is found, associated information is then transmitted back to the original picture.

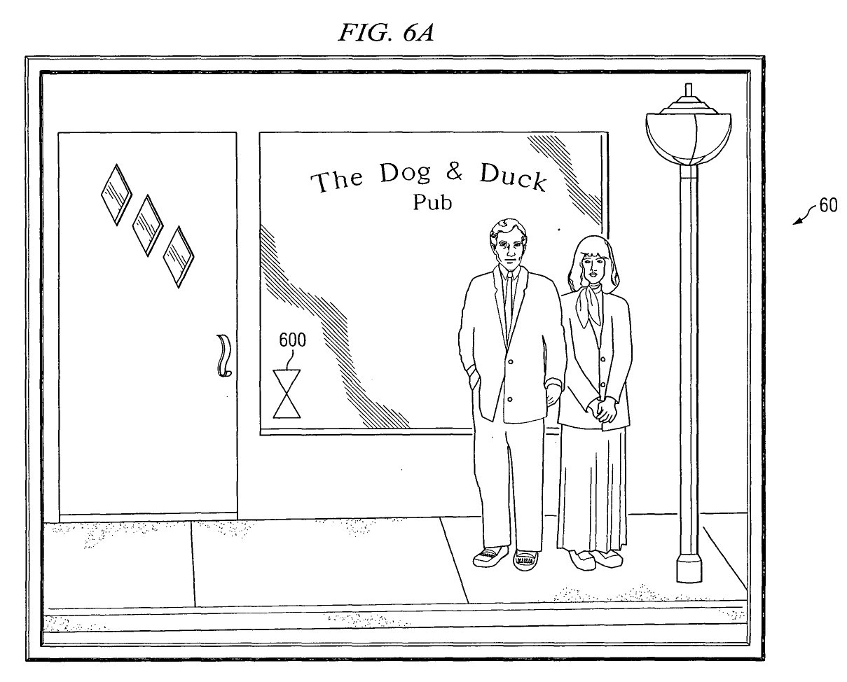

FIG. 5 is an illustration of picture 30 that has been updated with the information transmitted from the symbol registry. Picture 30 is now shown with graphic symbol 300 overlaid by hyperlink 500. Hyperlink 500 shows a connection for “Leverick Bay Resort.” When the user views picture 30, sees and selects hyperlink 500, information regarding Leverick Bay Resort may be provided to the selecting user.

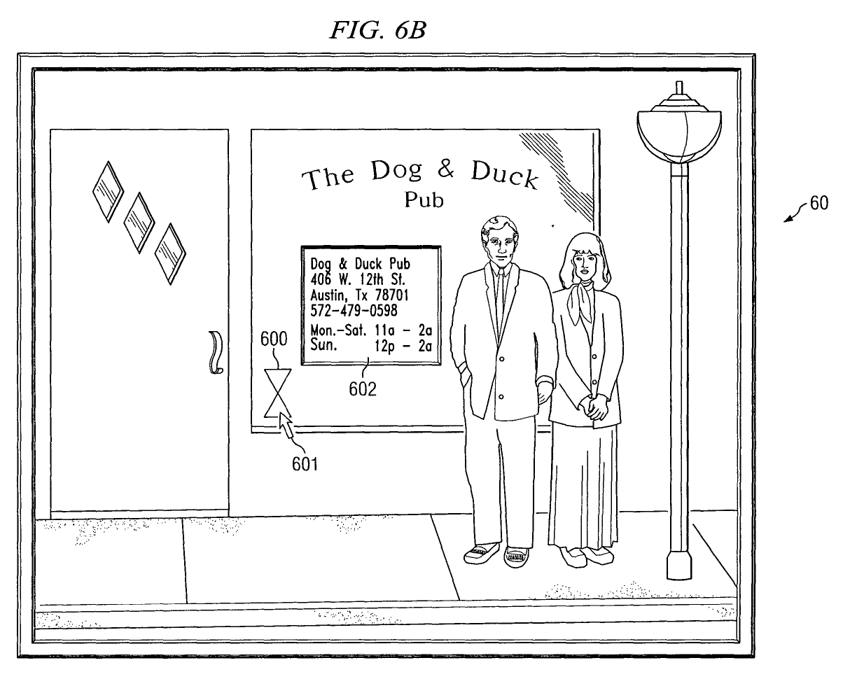

FIG. 6A is an illustration of picture 60 having unique symbol 600 configured to interact with one embodiment of the information management system described herein. Instead of providing a hyperlink to another URL, some transmitted information associated with unique symbol 600 may instead provide a pop-up box of information. FIG. 6B is an illustration of picture 60 updated with the related information from the information management system. In the illustrated embodiment, as the user rolls cursor 601 over unique symbol 600, pop-up box 602 appears providing information about the symbol owner or establishment. As shown in FIG. 6B, pop-up box 602 provides address, phone number, and hours of operation to the user.

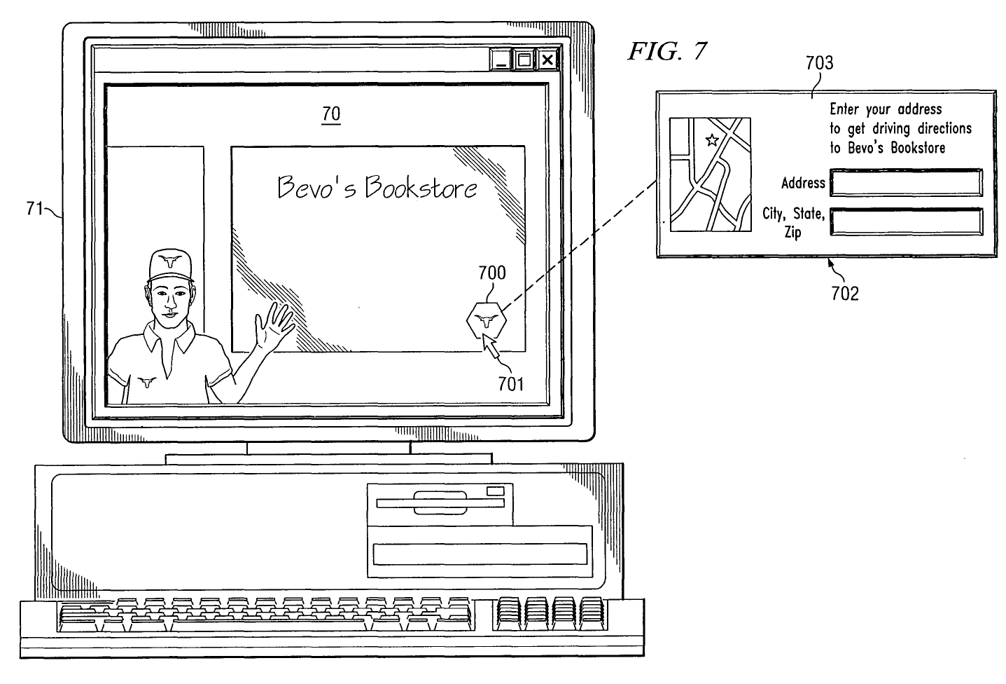

FIG. 7 is an illustration of picture 70 having graphic symbol 700 configured to interact with another embodiment of the present invention. Picture 70 is shown being displayed on computer 71. As a user rolls cursor 701 or selects graphic symbol 700, driving direction application 702 is activated allowing the user to interact with the application and view map 703 to get to the place shown in picture 70 having graphic symbol 700.

As illustrated in FIGS. 5, 6, and 7, many different combinations of information or applications may be provided for in operation of the information management as described here. In some embodiments, a hyperlink may be accompanied by a pop-up box and also an applet or application.

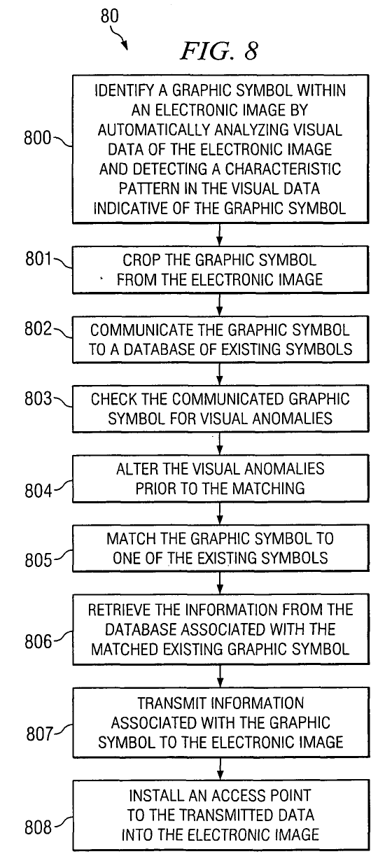

FIG. 8 is a flow chart depicting representative method 80 for implementing one embodiment of the information management system described herein. A graphic symbol may be identified, in step 800, within an electronic image by automatically analyzing visual data of the electronic image and detecting a characteristic pattern in the visual data indicative of the graphic symbol. In step 801, the graphic symbol may then be cropped from the electronic image. The graphic symbol may be communicated to a database of existing symbols in step 802, where, in step 803, the communicated graphic symbol is checked for visual anomalies. If visual anomalies are found, in step 804, they are altered prior to the matching. The graphic symbol is then matched to one of the existing symbols in step 805. If a match is found, information is retrieved in step 806 from the database associated with the matched existing graphic symbol. This information associated with the graphic symbol may then be transmitted to the electronic image, in step 807, where, in step 808, an access point to the transmitted data is installed into the electronic image.

1. A method for delivering information comprising:
identifying a graphic symbol within an electronic image;
communicating said graphic symbol to a database of existing symbols;
matching said graphic symbol to one of said existing symbols; and
transmitting information associated with said graphic symbol to said electronic image.

2. The method of claim 1 wherein said electronic image is obtained by one of:
a computer readable medium; and
an image capture device.

3. The method of claim 1 wherein said identifying comprises:
automatically analyzing visual data of said electronic image; and
detecting a characteristic pattern in said visual data indicative of said graphic symbol.

4. The method of claim 3 wherein said characteristic pattern comprises at least one of:
a size;
a shape; and
a set of colors.

5. The method of claim 1 further comprising:
cropping said graphic symbol from said electronic image prior to said communicating.

6. The method of claim 1 further comprises:
checking said communicated graphic symbol for visual anomalies; and
altering said visual anomalies prior to said matching.

7. The method of claim 6 wherein said visual anomalies comprise one or more of:
distortion;
blur;
noise;
brightness;
contrast;
perspective;
orientation; and
size.

8. The method of claim 1 further comprising:
retrieving said information from said database associated with said matched existing symbol.

9. The method of claim 1 further comprising:
installing an access point to said transmitted data into said electronic image.

10. The method of claim 9 wherein said access point comprises one or more of:
a hyperlink;
a web URL;
an applet;
a user-selectable object;
a pop-up information box; and
an application shortcut.

11. The method of claim 1 wherein said information comprises one or more of:
metadata;
hypertext markup language (HTML) tags;
a uniform resource locator (URL) address;
computer logic; and
an interactive multimedia file.

12. An information management system comprising:
client-side logic executable by a client processor for detecting a unique symbol displayed within a visual image; and
server-side logic executable by a server for matching said unique symbol to at least one of a plurality of stored symbols and returning data corresponding to said matched unique symbol to said client-side logic.

13. The information management system of claim 12 further comprising:
an image capture device for capturing said visual image.

14. The information management system of claim 12 wherein said client-side logic comprises:
an image recognition application for analyzing image data of said visual image.

15. The information management system of claim 12 wherein said client-side logic comprises:
a cropping application for separating image data corresponding to said unique symbol from a remainder of said visual image.

16. The information management system of claim 12 wherein said client-side logic comprises:
image logic for incorporating said returned data into said visual image; and
a graphical user interface tool for inserting a user access point to said returned data.

17. The information management system of claim 16 wherein said user access point comprises one or more of:
a hyperlink;
a user-selectable object;
a pop-up information box; and
an application shortcut.

18. The information management system of claim 12 further comprising:
a client communication interface for transmitting said unique symbol to said server; and
a server communication interface for receiving said unique symbol from said client and transmitting said data, wherein said client communication interface receives said data transmitted by said server.

19. The information management system of claim 12 wherein said server-side logic comprises:
a graphics application for repairing defects in said detected unique symbol;
a search application for searching said plurality of stored symbols for a match; and
an error checking application for checking for errors during execution of said search application.

20. The information management system of claim 19 further comprising:
an image manager for managing execution of said server-side logic on said server.

21. The information management system of claim 12 wherein said client comprises one or more of:
an image capture device;
a personal computer (PC); and
an application server in communication with one of said image capture device and said PC.

22. the information management system of claim 12 wherein said data comprises one or more of:
metadata;
hypertext markup language (HTML) tags;
a uniform resource locator (URL) address;
program logic; and
an interactive multimedia file.

23. A method for automatically distributing information to a consumer comprising:
registering a unique graphic symbol from a vendor;
storing information from said vendor related to said unique graphic symbol in a database;
receiving an image of said unique graphic symbol automatically acquired from a picture provided by said consumer;
searching said database to match said image to said unique graphic symbol; and
transmitting said information related to said unique graphic symbol to said picture when a match is found.

24. The method of claim 23 wherein said image is automatically acquired at a device of said consumer.

25. The method of claim 23 wherein said consumer obtains said picture from one of:
a computer readable medium; and
an image capture device.

26. The method of claim 23 further comprising:
creating said unique graphic symbol using a characteristic pattern, wherein said characteristic pattern comprises at least one:
a size;
a shape; and
a color scheme.

27. The method of claim 23 further comprising:
reviewing said received image of said unique graphic symbol for visual distortions; and
altering said visual distortions prior to said searching.

28. The method of claim 27 wherein said visual distortions comprise one or more of:
blur;
size;
noise;
brightness;
contrast;
perspective;
orientation; and
deformation.

29. The method of claim 23 further comprising:
searching said database for said information corresponding to said match.

30. The method of claim 23 wherein said information comprises one or more of:
metadata;
hypertext markup language (HTML) file;
a uniform resource locator (URL) address;
program logic; and
interactive multimedia file.

31. The method of claim 23 further comprising:
extracting said image of said unique brand from said picture using code accessible by said consumer.

32. The method of claim 31 wherein said code includes a cropping application for removing image data within said picture that is not related to said image of said unique graphic symbol.

33. The method of claim 23 further comprising:
inserting an interface object in said picture, wherein said interface object provides said consumer access to said transmitted information.

34. The method of claim 33 wherein said interface object comprises:
a hyperlink;
a web URL;
an applet;
a user-selectable object;
a dialog box; and
a short cut to an application.
